(19) United States
(12) Patent Application Publication
(10) Pub. No.: US 2007/0137715 A1
(43) Pub. Date: Jun. 21, 2007

(54) Hydraulic pressure control valve

(75) Inventor: Kiyokazu Ichikawa, Fukuroi-shi (JP)

Correspondence Address: CROWELL & MORING LLP;INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 11/641,660

(22) Filed: Dec. 20, 2006

(30) Foreign Application Priority Data
Dec. 20, 2005 (JP) 2005-365790

(51) Int. Cl. F16K 15/16

(52) U.S. Cl. 137/858

(57) ABSTRACT

A hydraulic pressure control valve for use in a hydraulic multiplate clutch assembly includes a valve plate having a ridge-shaped, elevated portion formed in a proximity of at least a part of the valve plate, where a deformation is to take place in a staking step to be performed upon assembly of the hydraulic pressure control valve. The ridge-shaped, elevated portion serves to prevent the deformation from spreading to a closing part of the valve plate for an associated oil leak hole.

### FIELD OF THE INVENTION

This invention relates to a hydraulic pressure control valve suitable for use in a hydraulic multiplate clutch by mounting it on a clutch piston in the hydraulic multiplate clutch.

### DESCRIPTION OF THE RELATED ART

FIG. 1 illustrates in cross section the outline of the construction of a hydraulic multiplate clutch equipped with a hydraulic pressure control valve. The hydraulic multiplate clutch 10 comprises a driving shaft 20, a clutch case 21, a driven shaft 30, a clutch piston 40, and so on.

Designated at numeral 22 is a spline groove, in which separator plates 23 are fitted. Numeral 32 indicates another spline groove formed on a hub 31 which is arranged on the side of the driven shaft 30, and friction plates 24 are fitted in the spline groove 32. Numeral 25 indicates friction linings bonded on both sides of the friction plates 24. The clutch piston 40 is provided with a leak hole 43 for hydraulic pressure, and a hydraulic pressure control valve 50 for controlling the leak hole 43 is mounted by a rivet 45 on a surface of the clutch piston 40, said surface being on the side of an oil chamber 60.

To engage the clutch, pressure oil is fed from an oilway 61 into the oil chamber 60. The hydraulic pressure control valve 50 is then pressed rightward as viewed in the drawing so that the leak hole 43 is closed. As a consequence, the clutch piston 40 is pressed rightward as viewed in the drawing, and by a pressing portion 41 of the clutch piston 40, the separator plates 23 and friction plates 24 are pressed against a stopper ring 26 to bring the clutch into engagement. To disengage the clutch, pressure fluid is drained from the oil chamber 60. The clutch piston 40 is then allowed to return leftward by a return spring 44 so that the clutch is disengaged. Any oil, which still remains in the oil chamber 60 at this time, is discharged through the leak hole 43. During the engagement of the clutch, a valve plate 51 of the hydraulic pressure control valve 50 keeps the leak hole 43 closed under the hydraulic pressure in the oil chamber 60.

Upon disengaging the clutch, centrifugal force is applied to the oil still remaining in the oil chamber 60, and therefore, the centrifugal force acts as force that closes the valve plate 51 of the hydraulic pressure control valve 50. If the spring force of the valve plate 51 is set strong enough to overcome the centrifugal force such that the valve can be opened, the hydraulic pressure control valve 50 cannot close the leak hole 43 until the pressure within the oil chamber 60 rises to a sufficiently high level upon engagement of the clutch. This causes a reduction in hydraulic pressure in the hydraulic pressure system. However, the use of a hydraulic pump of higher capacity with a view to avoiding such a reduction in hydraulic pressure leads to a reduction in overall efficiency, and moreover, a great deal of pressure oil (in other words, working oil) is quickly fed into the oil chamber, thereby developing a potential problem that the pressure may suddenly rise to produce a large engagement shock.

With a view to eliminating the above-mentioned inconvenience, it has hence been contemplated to provide the valve plate 51 with a weight (see, for example, JP-A-54-103940) If valve-opening force to be applied to a weight 52 under centrifugal force and valve-opening force to be applied to the oil remaining in the oil chamber 60 under the centrifugal force are set to become substantially equal to each other, drainage of pressure oil from the oil chamber 60 allows the oil pressure control valve 50 to open to permits a release of any remaining oil through the leak hole 43 even if the spring force of the valve plate 51 itself is small. Designated at numeral 42 in the drawing is a recessed portion formed inside the pressing portion 41 to accommodate the weight 52.

FIGS. 2A to 2C show a conventional valve plate, in which FIG. 2A is a plan view of the valve plate as viewed at a front side thereof, FIG. 2B is a side view of the valve plate as viewed in a direction S, and FIG. 2C is an end view of the valve plate as viewed in a direction T. These figures illustrate, in addition to the valve plate at numeral 51, a weight-mounting hole 53 for staking a weight 52 on the valve plate 51 (see FIG. 1) and a rivet hole 54 for mounting, as a valve-plate mounting hole, the valve plate 51 on the clutch piston 40 via the rivet 45 (see FIG. 1).

As readily envisaged from the drawings, the conventional valve plate 51 is a flat plate so that, when the weight 52 and rivet 45 are staked through the weight-mounting hole 53 and rivet hole 54, respectively, deformations produced in proximities of the weight-mounting hole 53 and rivet hole 54 spread throughout the valve plate 51. The valve plate 51 is, therefore, also deformed at a part thereof, which covers the oil leak hole 43 (see FIG. 1). This part is designated at numeral 55 in FIG. 2A. Such deformations of the valve plate 51 may lead to a potential problem that the oil leak hole 43 may not be controlled accurately and surely.

FIGS. 3A and 3B are similar to FIG. 2C. When each of the deformations of the valve plate 51 is seen at a corresponding end face thereof, the valve plate 51 is deformed convex in FIG. 3A and is deformed concave in FIG. 3B. Because the deformations occurred in the staking step spread to the leak-hole-controlling part as described above, the leak hole may not be controlled accurately and surely.

### SUMMARY OF THE INVENTION

As mentioned above, a deformation produced in a staking step which is performed to mount a valve plate on a clutch piston or a weight on the valve plate may spread to a leak-hole-controlling part of the valve plate, thereby developing the potential problem that the closure of the oil leak hole may not be effected completely.

To resolve the above-described problem, the present invention provides, in one aspect thereof, a hydraulic pressure control valve for use in a hydraulic multiplate clutch assembly, comprising:

a valve plate having a ridge-shaped, elevated portion formed in a proximity of at least a part of the valve plate, where a deformation is to take place in a staking step to be performed upon assembly of the hydraulic pressure control valve, such that the deformation is prevented from spreading to a closing part of the valve plate for an associated oil leak hole.

The present invention has made it possible to prevent a deformation, which is to be produced in a valve plate through a staking step, from spreading to a closing part of the valve plate for an associated oil leak hole, and therefore, to surely control the oil leak hole.

### BRIEF DESCRIPTION OF THE DRAWINGS

FIG. 1 is a cross-sectional view illustrating the construction of a hydraulic multiplate clutch.

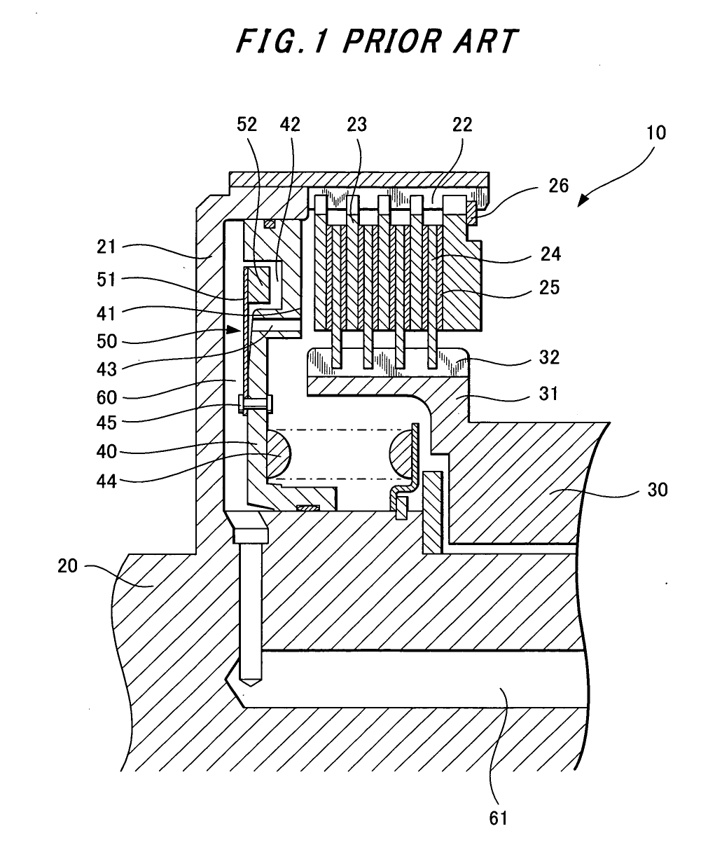

FIGS. 2A through 2C illustrate a conventional valve plate.

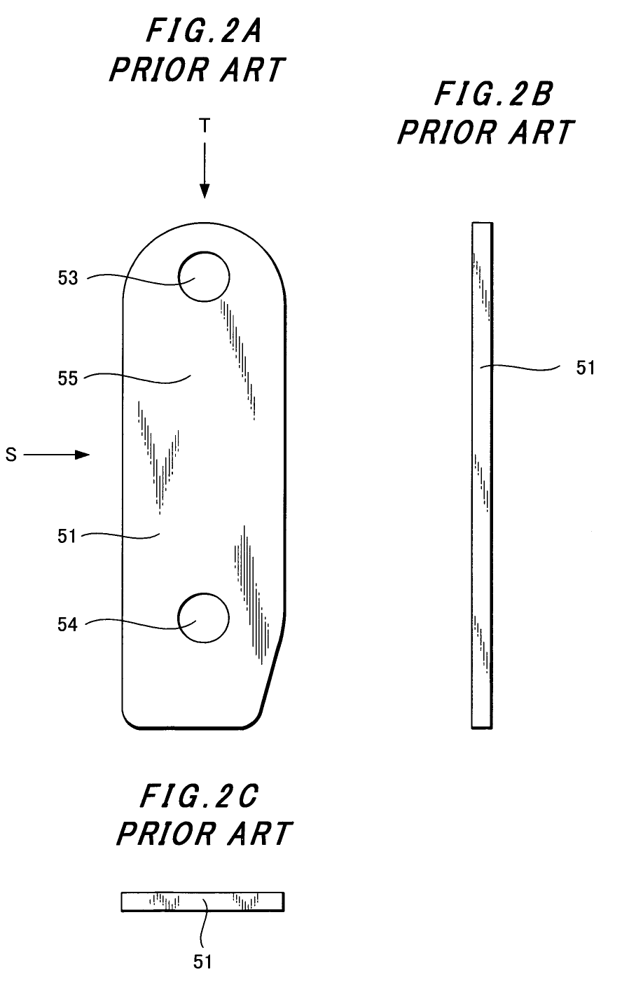

FIGS. 3A and 3B illustrate the forms of deformations of the conventional valve plate.

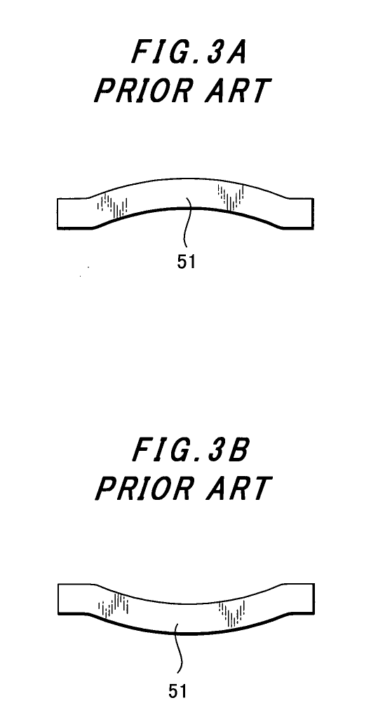

FIG. 4 is a schematic view of a hydraulic pressure control valve according to a first embodiment of the present invention, in which a valve plate is provided with two ridges as ridge-shaped elevated portions.

FIGS. 5A to 5C illustrate a valve plate in a hydraulic pressure control valve according to a second embodiment of the present invention in which the valve plate is provided with one ridge as a ridge-shaped elevated portion.

### DETAILED DESCRIPTION OF THE INVENTION AND PREFERRED EMBODIMENTS

The valve plate may be provided with two holes, one being adapted to mount a weight on the valve plate, and the other to mount the valve plate on an associated clutch piston. Two ridges may be arranged as ridge-shaped, elevated portions in the proximities of the two holes, respectively. Depending on conditions, one ridge may be arranged as a ridge-shaped, elevated portion in the proximity of only one of the two holes whichever closer to an associated oil leak hole.

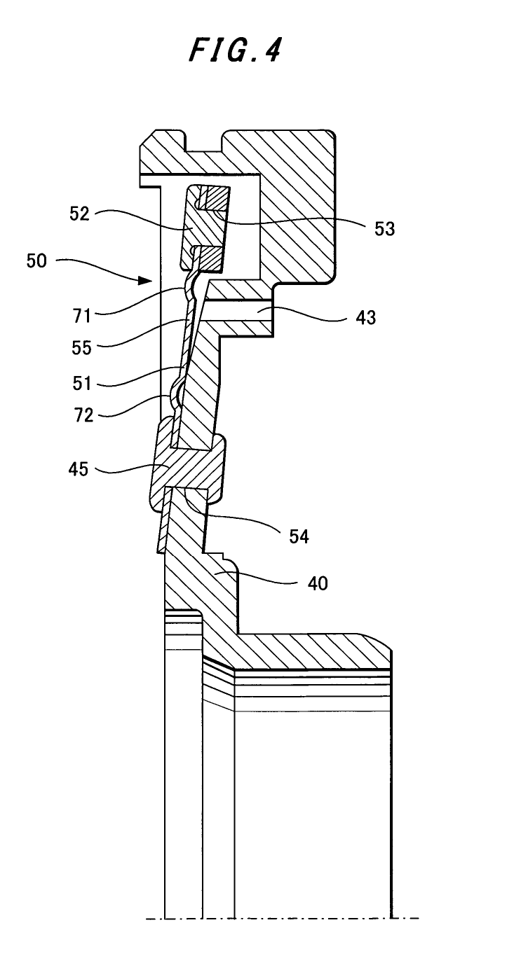

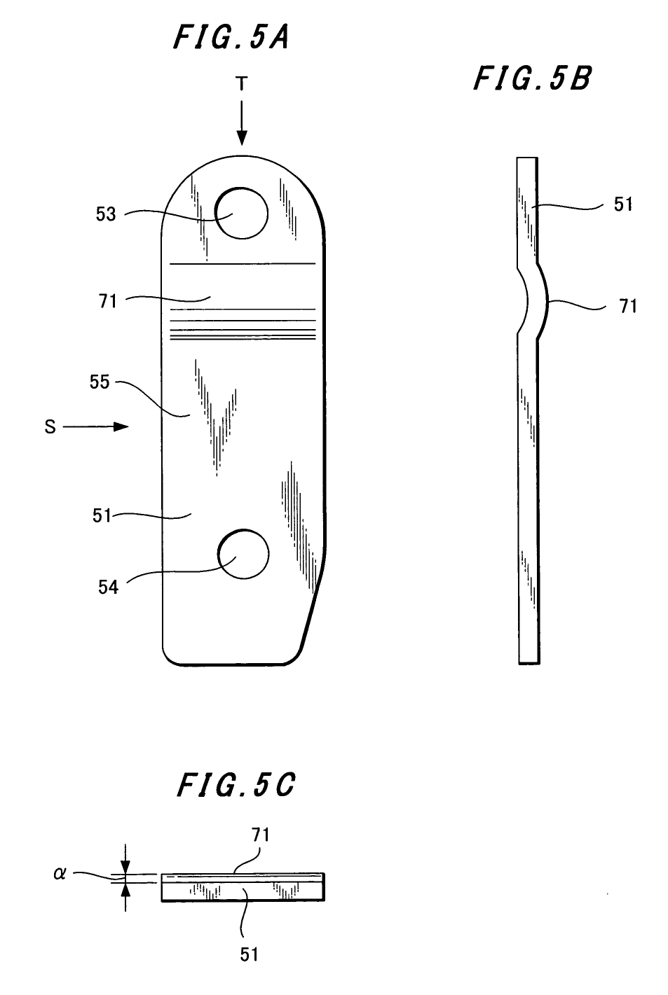

With reference to FIG. 4 and FIGS. 5A to 5C, the present invention will hereinafter be described in further detail based on its preferred embodiments.

Referring first to FIG. 4, the hydraulic pressure control valve according to the first embodiment of the present invention will be described. A weight 51 is staked on a valve plate 51 through a weight-mounting hole 53. The valve plate 51 is staked by a rivet 45 on a clutch piston 40 through a rivet hole 54. To prevent deformations, which are to be produced at the weight-mounting hole 53 and rivet hole 54 in staking steps, from spreading to a control portion 55 of the valve plate 51 for an oil leak hole 43, two ridges are formed in the proximities of parts of the valve plate 51, where the valve plate 51 is to be staked, respectively. The ridge in the proximity of the weight-mounting hole 53 is indicated by numeral 71, while the ridge in the proximity of the rivet hole 54 is designated at numeral 72.

Owing to the formation of these ridges 71, 72, deformations to be produced at the weight-mounting hole 53 and rivet hole 54 in the staking steps can be prevented from spreading to the control portion 55, i.e., the flat part of the valve plate 51 for the oil leak hole 43 because the ridges 71, 72 act as buffers or absorbers for the deformations.

Referring next to FIGS. 5A to 5C, the hydraulic pressure control valve according to the second embodiment of the present invention will be described. These drawings show a valve plate 51, a weight-mounting hole 53 for staking a weight on the valve plate 51, and as a valve-plate-mounting hole, a rivet hole 54 for staking the valve plate 51 on a clutch piston via a rivet. In this second embodiment, a ridge 71 is formed in a proximity of the weight-mounting hole 53 to prevent a deformation, which is to be produced in a staking step upon staking the weight in the weight-mounting hole 53, from spreading to a control portion 55, i.e., a flat part of the valve plate for an oil leak hole.

In FIG. 5C, letter “α” indicates an elevated height of the ridge 71. Preferably, this elevated height a may be in a range of from 0.05 mm to 0.2 mm or so.

As illustrated in FIG. 4, two ridges may be arranged, one being in the proximity of the weight-mounting hole 53, and the other in the proximity of the rivet hole 54 as the valve-plate-mounting hole. As an alternative, one ridge may be arranged in the proximity of only one of these holes 53, 54 whichever closer to the control portion 55 for the oil leak hole as shown in FIGS. 5A to 5C. It is to be noted that each ridge may comprise a plurality of ridges formed close to each other. Further, each ridge may preferably extend over substantially the entire width of the valve plate.

According to the present invention, it is possible to prevent a deformation of a valve plate, said deformation being to be produced in a staking step upon manufacture of a hydraulic pressure control valve, from spreading to a control portion of the valve plate for an oil leak hole. The thus-manufactured hydraulic pressure control valve can, therefore, operate accurately and surely, and functions stably.

This application claims the priority of Japanese Patent Application 2005-365790 filed Dec. 20, 2005, which is incorporated herein by reference.

1. A hydraulic pressure control valve for use in a hydraulic multiplate clutch assembly, comprising:
a valve plate having a ridge-shaped, elevated portion formed in a proximity of at least a part of said valve plate, where a deformation is to take place in a staking step to be performed upon assembly of said hydraulic pressure control valve, such that said deformation is prevented from spreading to a closing part of said valve plate for an associated oil leak hole.

2. A hydraulic pressure control valve according to claim 1, wherein said ridge-shaped, elevated portion is formed in a proximity of at least one of two holes formed through said valve plate, one of said holes being adapted to mount a weight on said valve plate, and the other to mount said valve plate on an associated clutch piston.

3. A hydraulic pressure control valve according to claim 1, wherein two ridge-shaped, elevated portions as defined in claim 1 are formed in proximities of two holes formed through said valve plate, respectively, one of said holes being adapted to mount a weight on said valve plate, and the other to mount said valve plate on an associated clutch piston.

4. A hydraulic pressure control valve according to claim 1, wherein said ridge-shaped, elevated portion extends over an entire width of said valve plate.

5. A hydraulic pressure control valve according to claim 1, wherein said ridge-shaped, elevated portion has an elevated height in a range of from 0.05 mm to 0.2 mm.
